(19) United States
(12) Patent Application Publication
(10) Pub. No.: US 2026/0345442 A1
(43) Pub. Date: Nov. 5, 2026

(54) NIPPLE FOR A FEEDING BOTTLE

(71) Applicant: Sandra Vivian Kahn, San Mateo, CA (US)

(72) Inventor: Sandra Vivian Kahn, San Mateo, CA (US)

(21) Appl. No.: 19/665,334

(22) Filed: May 1, 2026

Related U.S. Application Data
(60) Provisional application No. 63/798,452, filed on May 1, 2025.

(51) Int. Cl. A61J 11/02; A61J 9/00; A61J 11/04

(52) U.S. Cl. CPC A61J 11/02; A61J 9/001; A61J 11/04; A61J 2200/70

(57) ABSTRACT

The invention relates to a nipple for a feeding bottle and to a feeding bottle comprising such nipple. The nipple comprises a base portion having a lip-engagement region configured to engage lips of a user and to maintain a circumoral seal during feeding, and a sleeve portion extending from the base portion and comprising at least two openings at a distal end. The sleeve portion is configured to collapse under negative pressure generated during feeding so as to permit suction-driven delivery of liquid through one opening, while another opening is configured to allow ambient air into the sleeve portion after collapse thereof to facilitate restoration.

In some embodiments, the nipple has a generally frustoconical shape configured to engage a substantial portion of the circumoral perimeter of the user during feeding. The feeding bottle may further comprise pressure indication means configured to indicate negative pressure within the bottle body during use.

### CROSS-REFERENCE TO RELATED APPLICATIONS

This application claims the benefit of U.S. Provisional Patent Application No. 63/798,452, filed May 1, 2025, which is incorporated herein by reference in its entirety.

### FIELD OF THE INVENTION

The present invention relates to the field of feeding devices for infants and young children, particularly, the invention relates to nipple assemblies for feeding bottles and to feeding bottles comprising such nipple assemblies.

In particular, the invention relates to nipple assemblies configured to deliver liquid in response to suction generated by a user, and to feeding bottles incorporating such nipple assemblies.

The invention further relates to feeding bottles comprising pressure indication means, internal reservoirs, and bottle body configurations adapted to facilitate infant feeding.

### BACKGROUND OF THE INVENTION

Commercial feeding bottle nipples commonly present relatively large, gravity-fed openings. Such arrangements may permit delivery of liquid with limited dependence on negative pressure generated by the user during feeding.

In some known designs, liquid may be delivered laterally within the oral cavity and feeding may occur with reduced participation of oral structures involved in active sucking. As a result, bottle feeding dynamics may differ from those associated with natural lactation.

During natural lactation, the breast may locally present a firmer engagement surface, the infant may form a circumoral seal, generate negative pressure, and collapse the nipple so that milk is drawn centrally between the tongue and palate during sucking.

Known feeding bottles may include venting systems, flow-control arrangements, or monitoring features. However, no known arrangement is considered to provide, in a coordinated manner, a nipple having a lip-engagement region configured to support a circumoral seal, a collapsible sleeve portion responsive to suction, and optional pressure indication means configured to indicate suction conditions during feeding.

Accordingly, there remains a need for improved nipple assemblies and feeding bottles configured to more closely reproduce physiological sucking dynamics while optionally providing additional functional features.

### SUMMARY OF THE INVENTION

In order to address the needs previously identified, the present invention provides a nipple for a feeding bottle and a feeding bottle comprising such nipple, the nipple being configured to deliver liquid in response to suction generated by a user during feeding, as disclosed in the claims.

According to a first aspect, the nipple comprises a base portion comprising a lip-engagement region configured to engage lips of a user and to maintain a circumoral seal during feeding, and a sleeve portion extending from the base portion. The sleeve portion comprises at least two openings at a distal end thereof and is configured to collapse under a negative pressure generated during feeding so as to permit suction-driven delivery of liquid through one of the openings.

In some embodiments, the nipple, and in particular the base portion may have a generally frustoconical or truncated-cone shape. Such geometry may be configured to engage a substantial portion of the circumoral perimeter of the user during feeding, thereby facilitating formation of the circumoral seal and enabling generation of negative pressure during sucking.

Further, in alternative embodiments, the lip-engagement region comprises a textured surface having a plurality of ridges. Thus, the textured surface is configured to increase frictional engagement between the base portion and the lips of the user and to assist maintenance of the circumoral seal during feeding. Hence the textured surface with the ridges enhances the infant's seal and replicates the localized firmness of mammary tissue when engorged, thereby fostering a natural circumoral latch.

Also, within the context of the present invention, the expression “collapse” of the sleeve portion under negative pressure means that opposite wall regions of the sleeve portion move toward one another as a result of suction, thereby reducing an internal cross-section of the sleeve portion. In preferred embodiments, the sleeve portion may collapse along at least a substantial part of its axial length, for example at least 50%, at least 70%, or at least 80% of its axial length. Such collapse is intended to allow full tongue-to-palate contact of the user and routing of liquid centrally through Donders space.

In other alternatives, the other opening of the at least two openings is configured to allow ambient air into the sleeve portion after collapse thereof so as to facilitate restoration of the sleeve portion. Accordingly, liquid delivery may be associated with an active suction cycle comprising collapse and subsequent recovery of the sleeve portion.

In some embodiments, the base portion and the sleeve portion are formed from respective materials having different hardness values. In particular embodiments, the base portion has a Shore-A hardness between 45 and 60, and the sleeve portion has a Shore-00 hardness between 15 and 25.

In optional embodiments, the nipple may further comprise a valve configured to allow regulated airflow into the sleeve portion after collapse thereof to facilitate restoration and to tune re-inflation rate according to user suction strength.

According to a further aspect, the invention provides a feeding bottle comprising a bottle body and the nipple previously described, coupled to the bottle body. As known to the skilled person, the feeding bottle used to be formed by assembly of a plurality of parts, wherein the nipple is engaged to the bottle body by means of a crown or ring configured for that purpose, and wherein a cap is engageable to the crown or ring to cover the nipple when not in use.

In some embodiments, the bottle body comprises pressure indicative means configured to provide a visible and/or tactile indication of negative pressure within the bottle body indicative of suction by a user.

In particular embodiments, the pressure indicative means comprises a pressure-responsive membrane configured to retract when the negative pressure within the bottle body falls below a predetermined threshold. In some embodiments, the predetermined threshold is about −5 kPa. In further embodiments, the pressure indicative means further comprises a pressure sensor associated with the pressure-responsive membrane and a communication module configured to transmit pressure data to an external electronic device.

In optional embodiments, the bottle body is curved at least in a portion configured to facilitate feeding in an upright posture. In further embodiments, the feeding bottle comprises a collapsible internal reservoir positioned within the bottle body, the collapsible internal reservoir being configured to contract as liquid is withdrawn and to reduce suction resistance while maintaining suction-driven liquid transfer through the nipple. In particular embodiments, the collapsible internal reservoir comprises a flexible bag.

In some embodiments, the pressure-responsive membrane is positioned in a bottom portion of the bottle body.

Additional features, advantages, and embodiments of the invention will become apparent from the following description and the accompanying drawings.

### BRIEF DESCRIPTION OF THE DRAWINGS

The invention can be better understood with reference to the following drawings and description. The components in the figures are not necessarily to scale, emphasis instead being placed upon illustrating various embodiments of the invention.

FIG. 1 shows the nipple.

FIG. 2 shows the feeding bottle assembled with its main components in a cross-sectional view.

FIG. 3 shows the feeding bottle in an exploded view.

### DETAILED DESCRIPTION OF EXEMPLARY EMBODIMENTS

Reference will now be made in detail to exemplary embodiments of the invention, examples of which are illustrated in the accompanying drawings. Like reference numerals are used to designate like or corresponding elements throughout the drawings, where appropriate.

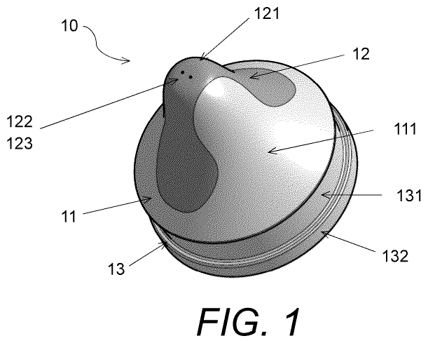

With reference first to FIG. 1, a nipple 10 according to an embodiment of the invention is shown. The nipple 10 may be configured to be mounted to a feeding bottle and to deliver liquid in response to suction generated by a user during feeding.

The nipple 10 comprises a base portion 11 and a sleeve portion 12 extending from the base portion 11. In the illustrated embodiment, the base portion 11 is arranged to be retained between components of the feeding bottle when assembled, although other coupling arrangements may also be used.

The base portion 11 comprises a lip-engagement region 111 configured to contact the lips of the user during feeding. In some embodiments, the lip-engagement region 111 may assist formation and maintenance of a circumoral seal around the nipple 10 while suction is applied.

Further, the nipple 10, and in particular the base portion 11 and the lip-engagement region 111, may present a generally frustoconical or truncated-cone shape. Such geometry may be configured to engage a substantial portion, or substantially the entire circumoral perimeter of the user during feeding. In this manner, contact between the lips and the lip-engagement region 111 may be distributed over an extended area, thereby facilitating formation of a circumoral seal and enabling generation of negative pressure during sucking.

In some embodiments, the lip-engagement region 111 may comprise a textured surface 1111. The textured surface 1111 may include a plurality of ridges 1112, grooves, projections, micro-textures, or equivalent surface formations configured to improve engagement with the lips and/or reduce slipping during feeding.

In particular embodiments, the textured surface 1111 of the lip-engagement region 111 comprises ridges 1112 having a height between 15 μm and 35 μm and spaced between 80 μm and 220 μm apart. In preferred embodiments, the ridges 1112 have a height of about 25 μm and are spaced between 100 μm and 200 μm apart.

In some embodiments, the base portion 11, and particularly the lip-engagement region 111, may provide a firmer engagement surface than the sleeve portion 12 so as to mimic localized firmness of mammary tissue during feeding and to support maintenance of the circumoral seal.

Opposite to the sleeve portion 12, the nipple 10 may further comprise a cylindrical portion 13 extending from the base portion 11. In the illustrated embodiment, the cylindrical portion 13 may be configured for coupling of the nipple 10 to the bottle body.

In some embodiments, the cylindrical portion 13 comprises a narrowed portion 131 having a diameter smaller than a maximum diameter of the base portion 11, thereby defining a region configured to be engaged by a crown 30. In further embodiments, the cylindrical portion 13 comprises a flange 132 at an end thereof configured to cooperate with the crown 30 and/or bottle body 21 so as to retain the nipple 10 in an assembled condition.

The sleeve portion 12 extends outwardly from the base portion 11 toward a distal end 121. At the distal end 121, the sleeve portion 12 comprises at least two openings 122, 123. In some embodiments, one opening 122 may be configured primarily for delivery of liquid, while another opening 123 may permit admission of ambient air into the sleeve portion 12 during a recovery phase.

In some embodiments, the at least two openings 122, 123 comprise perforations formed at the distal end 121 of the sleeve portion 12. At least one of the openings 122, 123 may have a diameter between 0.15 mm and 0.30 mm, thereby restricting passive liquid flow and promoting suction-driven delivery.

The sleeve portion 12 is configured to collapse under negative pressure generated by the user during sucking. Within the context of the present invention, collapse may include inward movement of opposed wall regions of the sleeve portion 12 such that an internal passage of the sleeve portion 12 is reduced. In preferred embodiments, collapse may occur along a substantial part of the axial length of the sleeve portion 12.

In some embodiments, the sleeve portion 12 may have a wall thickness between 0.2 mm and 0.4 mm, preferably about 0.3 mm. Also, the sleeve portion 12 may be configured to collapse along at least 80% of its axial length when subjected to negative pressure generated during feeding.

In some embodiments, collapse of the sleeve portion 12 may permit closer tongue-to-palate contact during feeding and may promote routing of liquid centrally within the oral cavity, for example through the space between the tongue and palate commonly referred to as Donders space.

In some embodiments, cooperation between collapse of the sleeve portion 12 and delivery through opening 122 may promote substantially central routing of liquid toward the region between the tongue and palate, thereby reducing lateral flow toward the cheeks compared with conventional gravity-fed nipples.

After collapse, ambient air may enter through opening 123 so as to facilitate restoration of the sleeve portion 12 toward an expanded condition. Accordingly, liquid delivery may be associated with an active suction cycle comprising collapse and subsequent recovery of the sleeve portion 12.

In some embodiments, the base portion 11 and the sleeve portion 12 are formed from materials having different hardness values. By way of example, the base portion 11 may have a Shore-A hardness between 45 and 60, while the sleeve portion 12 may have a Shore-00 hardness between 15 and 25. Other material combinations may also be used depending on desired sealing, flexibility, and durability characteristics.

In optional embodiments, the nipple 10 may further comprise a valve 14. The valve 14 may be configured to allow regulated airflow into the sleeve portion 12 after collapse thereof to facilitate restoration of the sleeve portion 12. In some embodiments, the valve 14 may be selected or adjusted to tune a re-inflation rate according to expected suction strength or desired feeding characteristics.

In embodiments comprising a valve (not shown), the valve may comprise an airflow passage or bleed opening having a diameter between 0.4 mm and 0.6 mm, configured to regulate admission of ambient air into the sleeve portion 12 after collapse thereof.

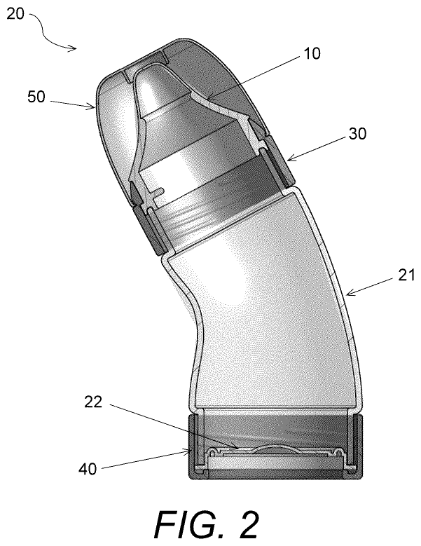

With reference now to FIG. 2, a feeding bottle 20 according to an embodiment of the invention is shown in assembled form. The feeding bottle 20 comprises a bottle body 21 and the nipple 10 coupled to the bottle body 21.

As is generally known in the art, the nipple 10 may be mounted to the bottle body 21 by means of a crown or ring 30 configured to secure the nipple 10 relative to the bottle body 21. A removable cap 50 may also be provided, for example engageable with the crown or ring 30, to cover the nipple 10 when not in use.

In some embodiments, the bottle body 21 comprises pressure indicative means configured to provide a visible and/or tactile indication of negative pressure within the bottle body 21 indicative of suction generated by the user.

In the illustrated embodiment, the pressure indicative means may comprise a pressure-responsive membrane 221. The membrane 221 may retract, flex, deform, or otherwise move when the pressure within the bottle body 21 falls below a predetermined threshold. In some embodiments, the threshold may be about −5 kPa, although other threshold values may be selected.

In some embodiments, the pressure-responsive membrane 221 has a thickness between 0.1 mm and 0.3 mm, preferably about 0.2 mm.

In some embodiments, the pressure indicative means 22 may further comprise a pressure sensor (not shown) associated with the membrane 221 and a communication module 223 configured to transmit pressure data to an external electronic device, such as a mobile phone, tablet, monitor, or cloud-based system.

In some embodiments, the pressure indicative means 22 may provide a visible indication, a tactile indication, an audible indication, and/or an electronic notification based on detected pressure conditions.

The bottle body 21 may be curved or bent at least in a portion 211 so as to facilitate feeding in an upright posture. In some embodiments, such geometry may improve handling ergonomics and/or feeding orientation.

In further embodiments, the feeding bottle 20 may comprise a collapsible internal reservoir (not shown) positioned within the bottle body 21. The collapsible internal reservoir may contract as liquid is withdrawn so as to reduce suction resistance while maintaining suction-driven liquid transfer through the nipple 10.

In particular embodiments, the collapsible internal reservoir may comprise a flexible bag (not shown), pouch, liner, or other deformable container configured to contain liquid within the bottle body 21.

In some embodiments, the collapsible internal reservoir may be removable, replaceable, disposable, or refillable.

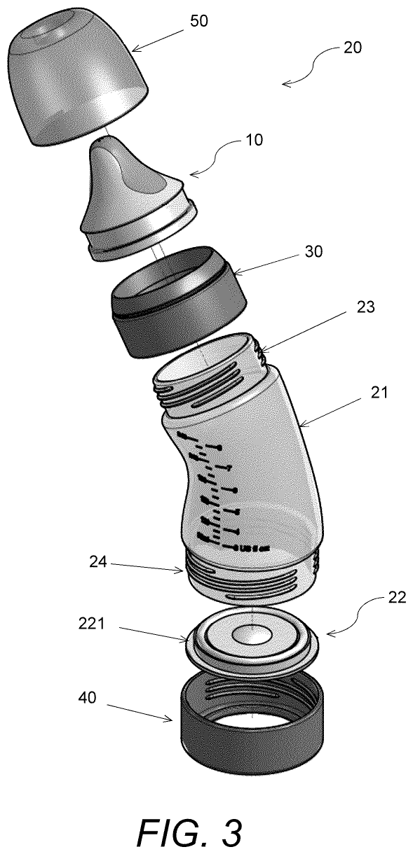

In the preferred embodiment shown in FIGS. 2 and 3, the pressure-responsive membrane 221 is positioned in a bottom portion 212 of the bottle body 21 and is held in position by a bottom sleeve 40 coupled to the bottle body 21. In the illustrated embodiment, the crown 30 and the bottom sleeve 40 are threadably engaged with the bottle body 21 in respective threaded ends 23, 24. However, other coupling arrangements, including snap-fit, bayonet, press-fit or equivalent retaining configurations, may also be used within the scope of the invention.

FIG. 3 illustrates an exploded view of the feeding bottle 20. In the illustrated embodiment, the bottle body 21, nipple 10, crown 30, bottom sleeve 40, optional pressure-responsive membrane 221, and optional collapsible internal reservoir (not shown) are shown separated from one another prior to assembly. The illustrated arrangement is merely exemplary, and the number, order, and configuration of components may vary.

As used herein, the expression feeding bottle may be used interchangeably, where appropriate, with baby bottle, infant bottle, nursing bottle, feeding device, or analogous terms.

It will be understood that the embodiments described herein are illustrative and non-limiting. Features described in connection with one embodiment may be combined with features of another embodiment unless technically incompatible. Modifications, substitutions, and equivalent arrangements falling within the scope of the appended claims are intended to be covered.

1. A nipple (10) for a feeding bottle (1), the nipple (10) comprising:
a base portion (11) comprising a lip-engagement region (111) configured to engage lips of a user and to maintain a circumoral seal during feeding; and
a sleeve portion (12) extending from the base portion (11) and comprising at least two openings (122, 123) at a distal end (121) thereof;
wherein the sleeve portion (12) is configured to collapse under a negative pressure generated during feeding so as to permit suction-driven delivery of liquid through one opening (122) of the at least two openings (122, 123); and
wherein the other opening (123) of the at least two openings (122, 123) is configured to allow ambient air into the sleeve portion (12) after collapse thereof to facilitate restoration of said sleeve portion (12).

2. The nipple (10) of claim 1, wherein the lip-engagement region (111) comprises a textured surface (1111) having a plurality of ridges (1112).

3. The nipple (10) of claim 1, wherein the base portion (11) and the sleeve portion (12) are formed from respective materials having different hardness values.

4. The nipple (10) of claim 3, wherein the base portion (11) has a Shore-A hardness between 45 and 60, and the sleeve portion (12) has a Shore-00 hardness between 15 and 25.

5. The nipple (10) of claim 1, further comprising a valve (13) configured to allow regulated airflow into the sleeve portion (12) after collapse thereof to facilitate restoration of the sleeve portion (12).

6. A feeding bottle (20) comprising:
a bottle body (21); and
the nipple (10) of claim 1, the nipple (10) being configured to be coupled to the bottle body (21);
wherein the bottle body (21) comprises a pressure indicative means (22) configured to provide a visible and/or tactile indication of negative pressure within the bottle body (21) indicative of suction by a user.

7. The feeding bottle (20) of claim 6, wherein the pressure indicative means (22) comprises a pressure-responsive membrane (221) configured to retract when the negative pressure within the bottle body (21) falls below a predetermined threshold.

8. The feeding bottle (20) of claim 7, wherein the predetermined negative-pressure threshold is about −5 kPa.

9. The feeding bottle (20) of claim 7, wherein the pressure indicative means (22) further comprises a pressure sensor (222) associated with the pressure-responsive membrane (221) and a communication module (223) configured to transmit pressure data to an external electronic device.

10. The feeding bottle (20) of claim 6, wherein the bottle body (21) is curved at least in a portion (211) configured to facilitate feeding in an upright posture.

11. The feeding bottle (20) of claim 6, further comprising a collapsible internal reservoir positioned within the bottle body (21), configured to contract as liquid is withdrawn and to reduce suction resistance while maintaining suction-driven liquid transfer through the nipple (10).

12. The feeding bottle (20) of claim 11, wherein the collapsible internal reservoir comprises a flexible bag.

13. The feeding bottle (20) of claim 6, wherein the pressure-responsive membrane (221) is positioned in a bottom portion (212) of the bottle body (21).
